(19) United States
(12) Patent Application Publication
(10) Pub. No.: US 2006/0160497 A1
(43) Pub. Date: Jul. 20, 2006

(54) Signal processing with certain materials

(76) Inventor: Kartik B. Ariyur, Minnetonka (IN)

Correspondence Address: HONEYWELL INTERNATIONAL INC., 101 COLUMBIA ROAD, P O BOX 2245, MORRISTOWN, NJ, 07962-2245, US

(21) Appl. No.: 11/035,778

(22) Filed: Jan. 14, 2005

(51) Int. Cl. H04B 1/02; H04B 7/08

(52) U.S. Cl. 455/102; 455/132

(57) ABSTRACT

Signal processing electromagnetic signals with specific materials. A processing portion may be composed of a specific material having a particular shape, a certain dielectric constant and a crystal structure that permits efficient propagation of the signals being processed. Such processing is very fast and utilizes little or no power due to its passive nature.

### BACKGROUND

The invention pertains to processing, and particularly to processing for wireless communications. More particularly, the invention pertains to low power and high speed processing.

### SUMMARY

The invention is a signal processor that uses specific materials in for processing electromagnetic signals.

### BRIEF DESCRIPTION OF THE DRAWING

FIG. 1 is a schematic diagram of a device using a material for an electronic processing function;

FIG. 2 is a block diagram of the transmitter of the system; and

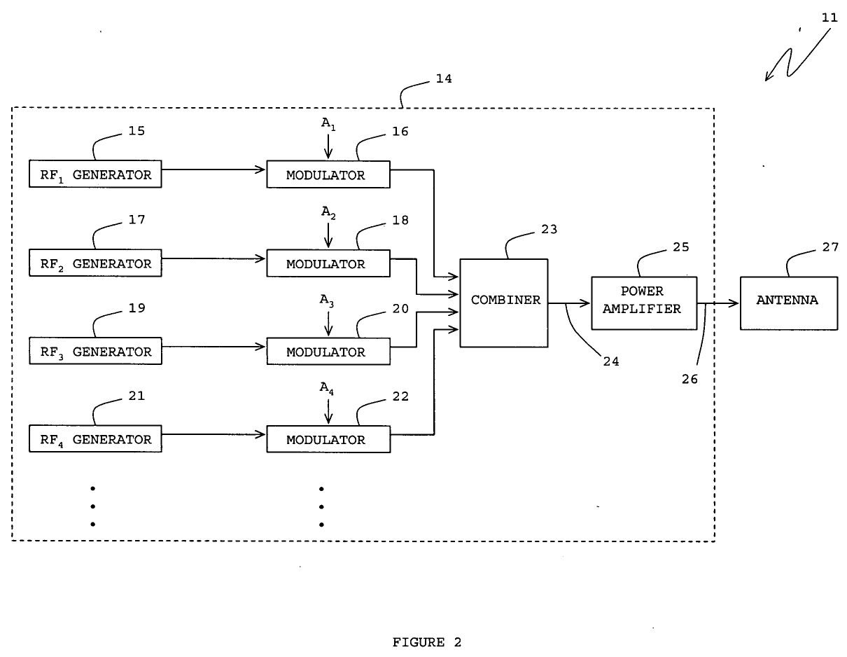

FIG. 3 is a block diagram of the demodulating portion of the receiver.

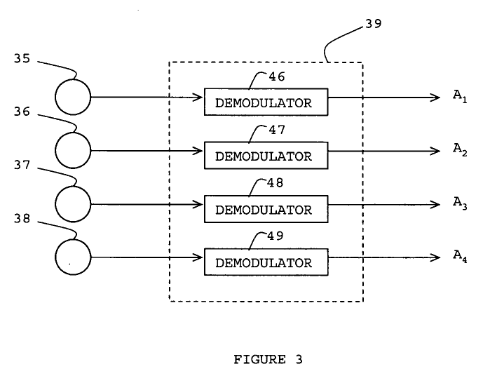

FIG. 4 illustrates a wavelength separating property of a prism relative to electromagnetic radiation; and

FIG. 5 is a table of materials, their transmission frequencies and respective dielectric constants.

### DESCRIPTION

The present invention relates to processing for wireless networks where special materials may be used as a processing mechanism. There is a need for high speed signal processing at low power consumption in wireless networks. High speed processing may eliminate time delays that can destabilize a system if a communication link is part of a feedback loop. The low power consumption aspect of the system may extend battery life of remote portions of the system thereby reducing human effort to replace or charge the batteries.

In a manner that colored glass filters light in a fashion of a passive band pass filter, or a prism that separates out light according to wavelength, which in effect performs a Fourier transform, one may use various kinds of materials in certain shapes tuned to specific electromagnetic frequency ranges to perform filtering and Fourier transform operations. Since such operations occur at the speed of wave propagation, the speed of operation is maximal. Additionally, these devices are passive, so no power is needed to-operate the devices. A limitation may be the size of the devices which increase with the wavelength of electromagnetic signals to be processed. These devices may have a convenient size with electromagnetic radiation in the millimeter (mm) range.

The materials used for various processing stages may be selected according to shape, dielectric constant and/or refractive index. Further, one may vary the charge distribution in the materials for varying or tuning the materials for different frequencies (as may be done in the optics field, for instance, fiber optics).

In the processor aspect of the design, one may first determine the wavelengths to be dealt with. Then, the crystal structure needed to pass or disperse radiation in the selected wavelength ranges may be determined. An illustrative example of the present processor may be a front end of a wireless receiver.

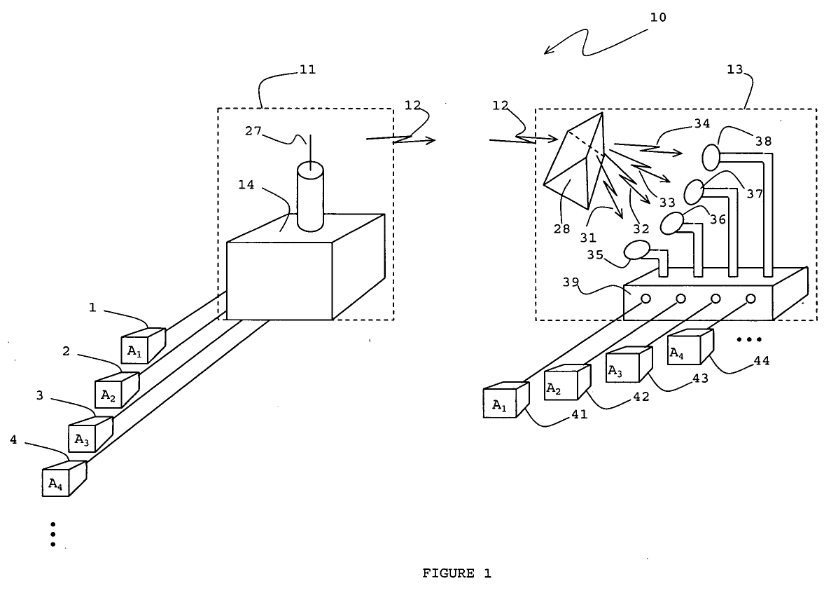

A communication system 10 in FIG. 1 may have a transmitter unit 11 that emits a radio frequency signal 12 to a receiver unit 13. Two or more messages or other kinds of information may be sent by transmitter unit 11 via a single emission or signal 12 to the receiver unit 13. For an illustrative example, the transmitter unit 11 may have a number of RF generators in a transmitter 14. Connected to each generator may be an amplitude modulator. Each amplitude modulator may have a signal input that represents a message. Input to transmitter unit 14 may be four signals, A₁, A₂, A₃ and A₄, from units 1, 2, 3 and 4, respectively. There may be more or less signals. Each signal may modulate an RF transmitter output via an amplitude modulator. Other kinds of modulation may be utilized.

Signal A₁ may modulate a first radio frequency RF₁ from an RF generator 15 via a modulator 16. Signal A₂ may modulate a second radio frequency RF₂ from an RF generator 17 via a modulator 18. Signal A₃ may modulate a third radio frequency signal RF₃ from an RF generator 19 via a modulator 20; and signal A₄ may modulate a fourth radio frequency signal RF₄ from an RF generator 21 via a modulator 22. There may be more signals, RF generators and modulators for providing modulated RF signals at additional frequencies.

The modulated RF signals A₁ω1(t)sin ω₁t, A₂ω₂(t)sinω₂t, A₃ω₃sinω₃t and A₄ω₄sinω₄t from modulators 16, 18, 20 and 22, respectively, may go to a combiner or multiplexer 23. The modulated RF signals are combined and conveyed as a resultant modulated RF signal 24 on one line which may be connected to an input of an RF power amplifier 25. The resultant signal 24 may amplified many times in terms of electrical power (I²V) into a power signal 26 which may go to an antenna 27. There may be four or more or less modulated RF signals combined. Antenna 27 may emit the power signal 26 as a radiation signal 12. Signal 12 may be emanated in all directions from antenna 27. However, the interested direction of signal 12 is the one looking towards a receiver unit 13. The bandwidth of the combined signal 24 may range from the lowest frequency to the highest frequency of the RF generators. Thus, signal 12 may be regarded as a broadband signal.

The modulated RF signal 12 may impinge and propagate through a prism shaped piece of a certain material having a selected dielectric constant depending on the bandwidth of the signal 12. Due to the propagation speed of electromagnetic radiation 12 varying according to frequency, there may be a “refraction” of signal 12 through a “prism” 28. Signal 12 may emanate from device 28 in a spread out fashion (i.e., in a spatial fashion according to frequency) in the same manner as a prism that receives a broadband light which may emanate from the prism in a spatially dispersed fashion according to wavelength or color, i.e., like a rainbow. Signal 12 may effectively be demultiplexed into signals 31, 32, 33 and 34, ranging from the shorter wavelength to the longer wavelength, respectively.

An array of antenna detectors 35, 36, 37 and 38 may be in the vicinity of prism 28 so as to detect signals 31, 32, 33 and 34. The array may be one of various configurations. The example shown in FIG. 1 is for illustrative purposes. The signals 31, 32, 33 and 34 may be input to demodulators 46, 47, 48 and 49 of device 39 via detectors 35, 36, 37 and 38, respectively. The demodulation of the signals 31, 32, 33 and 34 may result in signals A₁, A₂, A₃ and A₄, respectively, output to units 41, 42, 43 and 44.

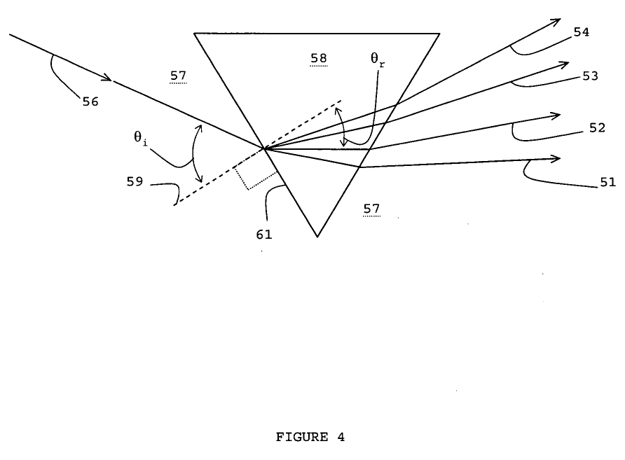

In the design of optical systems for the millimeter and submillimeter wavelength ranges one may choose from a number of materials having suitable properties. The choice of materials depends on losses and dielectric constants. Refractive index and absorption data are factors in the selection of dielectrics for optical design. The same principle may apply to light or electromagnetic radiation that enters a prism of optical or dielectric material, respectively. The index of refraction (n) of a material may be defined experimentally to be the ratio of the sine of the incident angle (θᵢ) for electromagnetic radiation 56 (FIG. 4) such as light in a vacuum (or air) to the sine of the refracted angle (θᵣ) in that material (e.g., prism 58), where n=sinθᵢ/sinθᵣ. The angle θᵢ is of the acute angle of incident ray 56 relative to a normal 59 (perpendicular line) relative to the incident surface 61. The angle θᵣ is of the acute angle of a refracted ray 52 relative to the normal 59 (perpendicular line) relative to the incident surface 61. The ray 52 may be refracted again as it goes from a material 58 to a less dense material 57 (air). The amount of refraction of the ray 56 and 52 is affected by the wavelength of the electromagnetic ray. Since rays 51, 52, 53 and 54 are refracted by different amounts in the same material transition, one may conclude that they have different wavelengths. The greater the refraction, shorter is the wavelength (λ). Thus, λ₅₁>λ₅₂>λ₅₃>λ₅₄.

In FIG. 4, a path of a ray 56 of electromagnetic radiation may pass from a less dense medium 57 (like air) into a more dense medium 58 (like glass or a dielectric material). The refraction (bending) of the ray 56 occurs as it transitions into the other material 58 because the electromagnetic radiation slows down in the material 58, so the index of refraction n may be found to be the ratio of the speed of the radiation (c) in a vacuum to the speed of light in a material (v), i.e., n=c/v.

The index of refraction may be given in terms of the electric permittivity ε and magnetic permeability μ by
n=(εμ)^{1/2}
and in terms of the dielectric constant kₑ and relative permeability kₘ by
n=(kₑkₘ)^{1/2}
Since μ and kₘ are usually ≈1, the previous two equations can usually be approximated using the Maxwell relation for the index of refraction as
n˜ε^{1/2} and
n˜kₑ^{1/2}.
Data may be presented in terms of the real part of the dielectric constant, \acute{ε}, and the loss tangent, tanδ, which may commonly be used in microwave electronics. The complex dielectric constant is
\hat{ε}=ε′−iε″
where i=\sqrt{−1}, and
tanδ=ε″/ε.
In millimeter optics, perhaps it may be more common to deal with the refractive index, n, and power absorption coefficient, α. These are related to the complex refractive index
\hat{n}=n−ik
with
α=4πνk/c,
where c is the speed of light, and ν is the frequency. For non-magnetic materials the two representations are related by
ε′=n²−k² and ε″=2nk
or, for low loss materials,
ε′=n² and tanδ=2k/n=αc/2πnν.
One may note that α is often given in units of cm⁻¹ or Np cm⁻¹. In the conventions of millimeterwave optics, the neper (Np) may be used as a measurement of power absorption (1 Np=4.343 dB), in contrast to the normal electrical engineering definition in terms of amplitude.

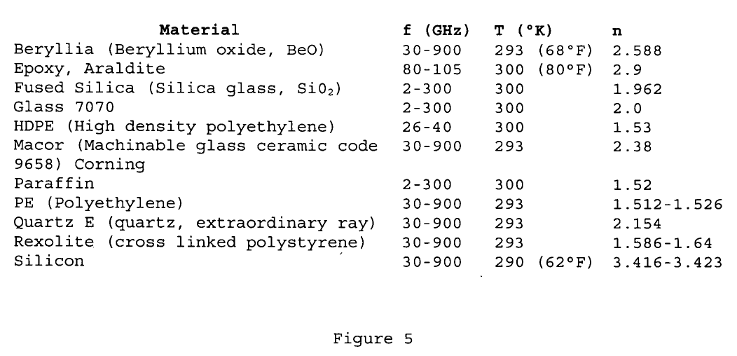

FIG. 5 is a table of various dielectric materials with frequency ranges, temperatures of testing and their resultant refractive indices.

Although the invention has been described with respect to at least one illustrative embodiment, many variations and modifications will become apparent to those skilled in the art upon reading the present specification. It is therefore the intention that the appended claims be interpreted as broadly as possible in view of the prior art to include all such variations and modifications.

What is claimed is:

1. A communication system comprising:
a plurality of radio frequency generators;
a plurality of modulators connected to the plurality of radio frequency generators;
a signal combiner connected to the plurality of radio frequency generators;
a radio frequency transmitter connected to the signal combiner; and
a receiver proximate to the transmitter;
wherein the receiver comprises:
a splitter;
a plurality of radio frequency detectors proximate to the splitter; and
a plurality of demodulators connected to the plurality of detectors.

2. The system of claim 1, wherein the splitter is a prism composed of a dielectric material.

3. The system of claim 2, wherein the dielectric material has an index of refraction relative to radio frequency radiation.

4. The system of claim 3, wherein:
each of the plurality of radio frequency generators may output a carrier wave having a frequency; and
the frequency of the carrier wave of each frequency generator is different from the frequency of the carrier wave of another radio frequency generator of the plurality of frequency generators.

5. The system of claim 4, wherein:
each modulator of the plurality of modulators is connected to a radio frequency generator of the plurality of radio frequency generators; and
each modulator of the plurality of modulators may modulate the carrier wave from the radio frequency generator to which the modulator is connected, with an information signal.

6. A method for communication, comprising:
generating a plurality of radio frequency signals at different wavelengths;
modulating some of the radio frequency signals with modulating signals;
combining the radio frequency signals into one signal;
transmitting the signal via a medium;
receiving the signal with a wavelength discriminator;
dispersing the signal according to wavelength from the wavelength discriminator into a plurality of radio frequency signals at different wavelengths;
detecting the plurality of radio frequency signals at different wavelengths; and
demodulating the plurality of radio frequency signals at different wavelengths into the modulating signals.

7. The method of claim 6, wherein the wavelength discriminator refracts the received signal at a varying angle according to wavelength into the plurality of radio frequency signals.

8. The method of claim 7, wherein the wavelength discriminator is a prism.

9. The method of claim 8, wherein the prism comprises a dielectric material.

10. Means for communicating comprising:
means for generating a plurality of electromagnetic signals;
means for modulating the plurality of electromagnetic signals with information signals;
means for combining the plurality of electromagnetic signals into a broadband electromagnetic signal;
means for wireless transmission of the broadband electromagnetic signal;
means for receiving the broadband electromagnetic signal;
means for discriminating the broadband electromagnetic signal into the plurality of electromagnetic signals; and
means for demodulating the plurality of electromagnetic signals and obtaining the information signals.

11. The means of claim 10, wherein the means for discriminating comprises an object that is at least partially transmissive of electromagnetic signals.

12. The means of claim 11, wherein the object comprises a material that may refract the broadband electromagnetic signal in directions according to wavelength.

13. The means of claim 12, wherein the object is a prism.

14. A signal processing system comprising:
an object having a radiation input and an output; and
wherein the object comprises a material that filters a certain frequency of radiation.

15. The system of claim 14, wherein the material is a mixture of components that may be adjusted to filter a selected bandwidth of radiation.

16. The system of claim 15, further comprising:
additional objects having radiation inputs and outputs; and
wherein the additional objects comprise mixtures of components that may be adjusted to filter selected frequencies of radiation.

17. The system of claim 16, wherein the objects comprise dielectric materials.

18. The system of claim 14, wherein the object is a prism.

19. The system of claim 18, wherein the prism spatially spreads out radiation according to wavelength.

20. The system of claim 19, wherein the prism comprises a mixture of material that may be adjusted to affect radiation in a selected manner.

21. The system of claim 20, wherein the material is a dielectric.

22. A communication method comprising:
providing a plurality of messages;
modulating a plurality of frequencies by the plurality of messages into modulated frequencies;
combining the modulated frequencies into one signal;
transmitting the one signal;
receiving the one signal;
dispersing the one signal into a plurality of modulated frequencies; and
demodulating the plurality of modulated frequencies into a second plurality of messages; and
wherein the dispersing the signal is effected by a material element having a dielectric constant.

23. The system of claim 22, wherein the material element is a prism.

24. The system of claim 23, wherein the prism comprises a dielectric material having a transmission between 2 and 300 GHz.
